(19) United States
(12) Patent Application Publication
(10) Pub. No.: US 2006/0003195 A1
(43) Pub. Date: Jan. 5, 2006

(54) Electrolyte membrane for fuel cell and fuel cell comprising the same

(76) Inventor: Hyung-Gon Noh, Suwon-si (KR)

Correspondence Address: CHRISTIE, PARKER & HALE, LLP, PO BOX 7068, PASADENA, CA, 91109-7068, US

(21) Appl. No.: 11/155,859

(22) Filed: Jun. 16, 2005

(30) Foreign Application Priority Data
Jun. 30, 2004 (KR) 10-2004-0050772

(51) Int. Cl. H01M 8/00

(52) U.S. Cl. 429/12; 429/33

(57) ABSTRACT

Provided are an electrolyte membrane for a fuel cell and a fuel cell including the same. The electrolyte membrane for a fuel cell includes a proton conductive polymer layer and hygroscopic polymer layers placed on one side or on both sides of the proton conductive polymer layer. The electrolyte membrane has excellent hygroscopic properties and can be used for a self-humidifying fuel cell.

### CROSS REFERENCE TO RELATED APPLICATION

This application claims priority to and the benefit of Korean Patent Application No. 10-2004-0050772 filed in the Korean Intellectual Property Office on Jun. 30, 2004, which is hereby incorporated by reference in its entirety for all purposes as if fully set forth herein.

### FIELD OF THE INVENTION

The present invention relates to an electrolyte membrane for a fuel cell, and a fuel cell comprising the same, and more particularly, to a self-humidifying electrolyte membrane for a fuel cell and a fuel cell comprising the electrolyte membrane.

### BACKGROUND OF THE INVENTION

A fuel cell is an electric power generating system that converts chemical reaction energy between oxidant and hydrogen or a hydrocarbon-based material, such as methanol, ethanol, or natural gas, directly into electric energy.

A fuel cell can be classified as a phosphoric acid type, a molten carbonate type, a solid oxide type, a polymer electrolyte type, or an alkaline type depending upon the kind of electrolyte used. Although each fuel cell basically operates in accordance with the same principles, the kind of fuel, the operating temperature, the catalyst, and the electrolyte may vary depending on the type of fuel cell.

Recently, polymer electrolyte membrane fuel cells (PEMFC) have been developed with power characteristics superior to those of conventional fuel cells, lower operating temperatures, and faster starting and response characteristics. Such fuel cells have advantages in that they can be applied to a wide array of fields such as transportable electrical sources for an automobiles, as distributed power sources such as for houses and public buildings, and as small electrical sources for electronic devices.

The polymer electrolyte fuel cell is essentially composed of a stack, a reformer, a fuel tank, and a fuel pump. The fuel pump produces fuel stored in the fuel tank to the reformer. The reformer reforms the fuel to generate the hydrogen gas and supplies the hydrogen gas to the stack. At the stack, the hydrogen gas is electrochemically reacted with oxidant to generate the electrical energy.

Another type of fuel cell is a direct oxidation fuel cell (DOFC) in which a liquid methanol fuel is directly introduced to the stack. The direct oxidation fuel cell can omit the reformer which is essential for the polymer electrolyte fuel cell.

According to the above-mentioned fuel cell system, a stack, which substantially generates electricity, is composed of several to scores of unit cells stacked upon one another. Each of the unit cells is formed of a membrane-electrode assembly (MEA) and separators. The membrane-electrode assembly has a structure where an anode, which is also referred to as a fuel electrode or an oxidation electrode, and a cathode, which is also referred to as an air electrode or a reduction electrode, are attached to each other with a polymer electrolyte membrane between them. The separators provide paths for producing fuel to the anode and oxidant to the cathode, as well as acting as a conductor for connecting the anode and the cathode of each membrane-electrode assembly serially. In operation, an electrochemical oxidation reaction of the fuel occurs at the anode, while an electrochemical reduction reaction of oxidant occurs at the cathode. From the transfer of electrons generated in the process, electricity, heat and water are produced. As for a polymer electrolyte membrane that performs the role of an electrolyte in the membrane-electrode assembly, a fluorine-based electrolyte membrane, e.g., a perfluorosulfonate ionomer membrane, is generally used. However, since a fluorine-based polymer electrolyte membrane cannot reveal its proton conductivity until a sulfonic acid group (—SO₃H) is hydrated, there is a shortcoming that it additionally requires a humidifier.

### SUMMARY OF THE INVENTION

In one embodiment of the present invention, an electrolyte membrane is provided for a fuel cell that has excellent hygroscopic (moisture-absorbing) properties.

In another embodiment of the present invention, a fuel cell is provided including the electrolyte membrane.

According to an embodiment of the present invention, an electrolyte membrane for a fuel cell includes a proton conductive polymer layer and hygroscopic polymer layers placed on one side or on both sides of the proton conductive polymer layer.

According to another embodiment of the present invention, a fuel cell includes a membrane-electrode assembly including the electrolyte membrane described above, and separators placed to contact both sides of the membrane-electrode assembly.

### BRIEF DESCRIPTION OF THE DRAWINGS

The accompanying drawings, which are incorporated in and constitute a part of the specification, illustrate embodiments of the invention, and together with the description, serve to explain the principles of the invention:

FIG. 1 is a cross-sectional diagram illustrating an electrolyte membrane for a fuel cell in accordance with an embodiment of the present invention;

FIG. 2 is a cross-sectional diagram illustrating a unit cell of the fuel cell in accordance with an embodiment of the present invention; and

FIG. 3 is a graph presenting current densities of fuel cells prepared in accordance with Example 2 and Comparative Example 1.

### DETAILED DESCRIPTION

In the following detailed description, certain embodiments of the invention have been shown and described, simply by way of illustration. However, as will be realized, the invention is capable of modification in various respects, all without departing from the invention. Accordingly, the drawings and description are to be regarded as illustrative in nature, and not restrictive.

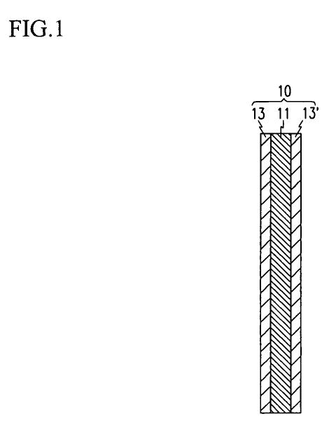

FIG. 1 is a cross-sectional diagram illustrating a structure of an electrolyte membrane for a fuel cell in accordance with the present invention. As shown in FIG. 1, the electrolyte membrane 10 comprises a proton conductive polymer layer 11 and hygroscopic polymer layers 13 and 13′ placed on one side or on both sides of the proton conductive polymer layer 11.

The proton conductive polymer layer 11 typically includes a proton conductive polymer which is used as a material for the electrolyte membrane for a fuel cell. Suitable proton conductive polymers include perfluorine-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof. Preferably, the proton conductive polymer layer includes one or more proton conductive polymers selected from the group consisting of poly(perfluorosulfonic acid), poly(perfluorocarboxylic acid), copolymers of tetrafluoroethylene and fluorovinylether including a sulfonic acid group, defluoridated polyetherketone sulfides, aryl ketones, poly(2,2′-(m-phenylene)-5,5′-bibenzimidazole), poly(2,5-benzimidazole), and combinations thereof. However, the invention is not intended to be limited to these particular materials.

The hygroscopic polymer layers 13 and 13′ absorb water and provide water to the proton conductive polymer layer. Suitable hygroscopic polymers include polymers having a hydrophilic functional group such as an acrylic acid group, a hydroxyethyl methacrylate group, a hydroxyl group, a sulfonic acid group, a phosphoric acid group or combinations thereof. Preferred polymers include polyacrylic acid, polyvinyl alcohol (PVA), polyethylene oxide (PEO), polyhydroxyethylmethacrylate (PHEMA), and polymers having a hydrophilic functional group selected from the group consisting of a hydroxyl group, a sulfonic acid group, an acrylic acid group or combinations thereof on a branch thereof.

The hygroscopic polymer layers are provided as porous thin films. In one embodiment, they have an average thickness of 2 to 10 μm, and preferably, they have an average thickness of 3 to 8 μm. If the average thickness of the hygroscopic polymer layers is less than 2 μm, the hygroscopic polymer layers cannot maintain sufficient hygroscopicity. When the thickness exceeds 10 μm, the proton permeability of the hygroscopic polymer layers can be degraded. Protons transfer through water, and because the hygroscopic polymers in the hygroscopic polymer layers adsorb water, excellent proton conductivity can be maintained.

The hygroscopic polymer layers can be formed by coating a composition containing a hygroscopic polymer or by attaching a porous film. Suitable materials include porous cloth or non-woven fabrics having high proton permeability.

Conventional coating methods can be used to form the hygroscopic polymer layers.

The electrolyte membrane of the present invention which includes the proton conductive polymer layer and the hygroscopic polymer layers has excellent hygroscopicity. Thus, it can be used for a self-humidifying fuel cell that can be driven without requiring an additional humidifier.

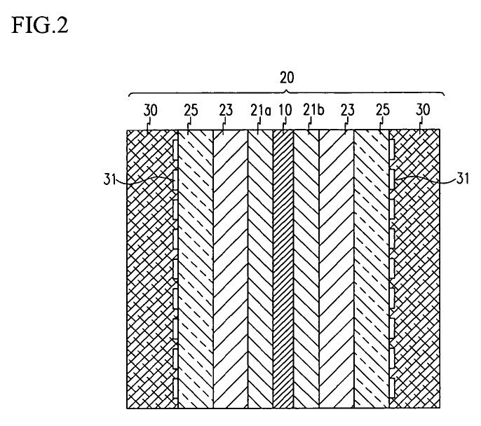

FIG. 2 is a cross-sectional diagram describing a unit cell of the fuel cell in accordance with an embodiment of the invention. However, the fuel cell of the present invention is not limited to that of FIG. 2.

The fuel cell of this embodiment of the invention comprises a membrane-electrode assembly (MEA) 20 including the electrolyte membrane 11 for a fuel cell and separators 30 placed to contact both sides of the membrane-electrode assembly.

The membrane-electrode assembly 20 includes the electrolyte membrane 10 for a fuel cell, a cathode catalyst layer 21a formed on one side of the electrolyte membrane 10, an anode catalyst layer 21b formed on the other side of the electrolyte membrane 10, and a pair of gas diffusion layers (GDL) 25, one between the external surface of each of the cathode catalyst layer 21a and the anode catalyst layer 21b and the separators 30. Optional microporous layers 23 can be provided between each of the cathode catalyst layer 21a and the anode catalyst layer 21b and the corresponding gas diffusion layers 25.

According to another embodiment of the present invention, the hygroscopic polymer layer is placed only on only one side of the proton conductive polymer layer. In this embodiment, it is preferred to place the hygroscopic polymer layer in contact with the cathode catalyst layer 21a which generates water by combining protons and oxidant. The oxidant may be air or oxygen.

Suitable catalysts for the cathode catalyst layer 21a and the anode catalyst layer 21b of the membrane-electrode assembly include platinum, ruthenium, osmium, platinum-ruthenium alloys, platinum-osmium alloys, platinum-palladium alloys, platinum-M alloys where M is at least one transition metal selected from the group consisting of Ga, Ti, V, Cr, Mn, Fe, Co, Ni, Cu, and Zn, and combinations thereof. Preferred catalysts include platinum, ruthenium, osmium, platinum-ruthenium alloys, platinum-osmium alloys, platinum-palladium alloys, platinum-cobalt alloys, platinum-nickel alloys, and combinations thereof.

Suitable materials for the gas diffusion layers 25 of the membrane-electrode assembly include carbon paper or carbon cloth.

Suitable materials for the microporous layers 23 are carbon layers having micropores of less than several micrometers. Preferred materials include graphite, carbon nanotubes (CNT), fullerene (C60), activated carbon, carbon nanohorns, and carbon black. The separators 30 each include a plurality of flow channels 31 through which fuel and/or air can pass.

Since the fuel cell comprising the electrolyte membrane has excellent hygroscopicity, it can be a self-humidifying fuel cell that is operated both with or without an additional humidifier.

The following examples further illustrate the present invention in detail but they are not to be construed to limit the scope thereof.

### EXAMPLE 1

An electrolyte membrane for a fuel cell was prepared by coating a poly (perfluorosulfonic acid) membrane made of Nafion® produced by the DuPont Company, with a polyhydroxyethylmethacrylate (PHEMA) film having an average thickness of 10 μm on both sides by using a doctor blade.

### EXAMPLE 2

An electrolyte membrane for a fuel cell was prepared by coating a poly (perfluorosulfonic acid) membrane (Nafion® produced by the DuPont Company), with a polyhydroxyethylmethacrylate (PHEMA) film having an average thickness of 5 μm on both sides by using a doctor blade.

### EXAMPLE 3

An electrolyte membrane for a fuel cell was prepared by coating a poly (perfluorosulfonic acid) membrane (Nafion® produced by the DuPont Company), with a polyethylene oxide (PEO) film having an average thickness of 10 μm on both sides by using a doctor blade.

### EXAMPLE 4

A membrane-electrode assembly was prepared by forming a cathode catalyst layer and an anode catalyst layer including a platinum catalyst on two pieces of carbon cloth and placing the cathode catalyst layer and the anode catalyst layer on both sides of the electrolyte membrane prepared in accordance with Example 1.

Subsequently, a fuel cell was prepared by fabricating a plurality of unit cells by placing separators, i.e., bipolar plates, having flow channels on both sides of each membrane-electrode assembly, and then stacking the unit cells one on another.

### EXAMPLE 5

A fuel cell was prepared in the same method as Example 4, except that the electrolyte membrane formed in Example 2 was used.

### EXAMPLE 6

A fuel cell was prepared in the same method as Example 4, except that the electrolyte membrane formed in Example 3 was used.

### COMPARATIVE EXAMPLE 1

A fuel cell was prepared by the same method as Example 4, except that a poly (perfluorosulfonic acid) membrane (Nafion® produced by the DuPont Company), was used as an electrolyte membrane for the fuel cell.

### COMPARATIVE EXAMPLE 2

An alcohol solution of perfluorosulfonic acid resin was cast into a membrane having a thickness of 5 μm. Then, acrylic acid resin was mixed with an alcohol solution of perfluorosulfonic acid resin, and the mixture solution was cast into an intermediate layer having a thickness of 90 μm. Subsequently, an electrolyte membrane for a fuel cell was prepared by casting an alcohol solution of perfluorosulfonic acid resin, as used in the above, to form a layer having a thickness of 5 μm on top of the intermediate layer.

A fuel cell was prepared in the same method as Example 4, except that the above-prepared electrolyte membrane was used.

With respect to the electrolyte membrane for a fuel cell prepared in accordance with Example 1 and the poly (perfluorosulfonic acid) membrane used in Comparative Example 1, hygroscopicity and proton conductivity were measured. The hygroscopicity was measured by weighing the amount of water absorbed while water vapor flowed to the respective electrolyte membranes for the respective fuel cells for five hours, and the proton conductivity was measured by using a proton conductivity measuring apparatus. The measurement results were as presented in Table 1.

TABLE 1

| | Hygroscopicity of | Proton Conductivity of |
|---|---|---|
| | Electrolyte Membrane | Electrolyte Membrane |
| Example 1 | 300% | 0.13 S/cm |
| Comparative | 60% | 0.11 S/cm |
| Example 1 | | |

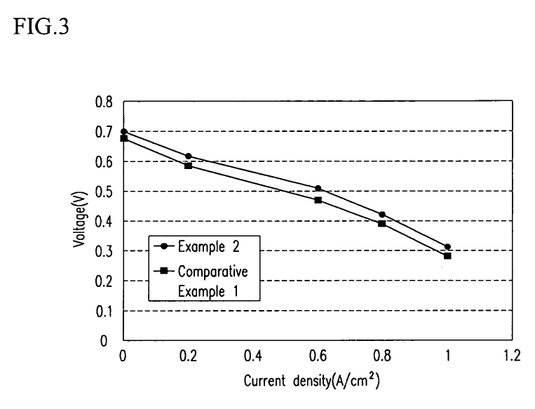

It can be seen from Table 1 that the polymer electrolyte membrane prepared in accordance with Example 1 of the present invention has hygroscopicity that is five times as high as the electrolyte membrane of Comparative Example 1, and it also has excellent proton conductivity. Also, current densities of the fuel cells prepared in accordance with Example 2 and Comparative Example 1 were measured by operating the fuel cells without attaching an additional humidifier. The measurement results were as shown in FIG. 3. It can be seen from FIG. 3 that the fuel cell of the present invention has an excellent current density although it does not have an additional humidifier.

The electrolyte membrane for a fuel cell, which is suggested in the present invention, has an advantage that it has an excellent hygroscopicity and it can be used for a self-humidifying fuel cell.

What is claimed is:

1. An electrolyte membrane for a fuel cell, comprising:
a proton conductive polymer layer; and
a hygroscopic polymer layer placed on at least one side of the proton conductive polymer layer.

2. The electrolyte membrane of claim 1, wherein the hygroscopic polymer layer comprises a material selected from the group consisting of perfluorine-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

3. The electrolyte membrane of claim 1, wherein the proton conductive polymer layer comprises a material selected from the group consisting of poly(perfluorosulfonic acid), poly(perfluorocarboxylic acid), copolymers of tetrafluoroethylene and fluorovinylether including a sulfonic acid functional group, defluoridated polyetherketone sulfides, aryl ketones, poly(2,2′-(m-phenylene)-5,5′-bibenzimidazole), poly(2,5-benzimidazole), and combinations thereof.

4. The electrolyte membrane of claim 1, wherein the hygroscopic polymer layer comprises at least one polymer having a hydrophilic functional group selected from the group consisting of acrylic acid groups, hydroxyethyl methacrylate groups, hydroxyl groups, sulfonic acid groups, phosphoric acid groups and combinations thereof.

5. The electrolyte membrane of claim 1, wherein the hygroscopic polymer layer comprises at least one polymer selected from the group consisting of polyacrylic acid, polyvinyl alcohol (PVA), polyethylene oxide (PEO), polyhydroxyethylmethacrylate (PHEMA), and polymers having a hydrophilic functional group selected from the group consisting of a hydroxyl group, a sulfonic acid group, an acrylic acid group, and combinations thereof.

6. The electrolyte membrane of claim 1, wherein the hygroscopic polymer layer has a thickness from 2 to 10 μm.

7. The electrolyte membrane of claim 1, wherein the hygroscopic polymer layer has a thickness from 3 to 8 μm.

8. The electrolyte membrane of claim 1, wherein the hygroscopic polymer layer is a porous film.

9. The electrolyte membrane of claim 1, wherein the hygroscopic polymer layer is a porous cloth or non-woven fabric.

10. A fuel cell, comprising:
a membrane-electrode assembly including an electrolyte membrane for a fuel cell comprising a proton conductive polymer layer and at least one hygroscopic polymer layer on a side of the proton conductive polymer layer; and
a pair of separators, one on each side of the membrane-electrode assembly.

11. The fuel cell of claim 10 further comprising:
a cathode catalyst layer formed on a first side of the electrolyte membrane;
an anode catalyst layer formed on a second side of the electrolyte membrane; and
a pair of gas diffusion layers, one in contact with the cathode catalyst layer and the other in contact with the anode catalyst layer.

12. The fuel cell of claim 11, wherein just one hygroscopic polymer layer is provided on one side of the proton conductive polymer toward the cathode catalyst layer.

13. The fuel cell of claim 11, wherein the cathode catalyst layer and the anode catalyst layer of the membrane-electrode assembly each independently comprises a catalyst selected from the group consisting of platinum, ruthenium, osmium, platinum-ruthenium alloys, platinum-osmium alloys, platinum-palladium alloys, platinum-M alloys where M is at least one transition metal selected from the group consisting of Ga, Ti, V, Cr, Mn, Fe, Co, Ni, Cu, and Zn, and combinations thereof.

14. The fuel cell of claim 11, wherein the cathode catalyst layer and the anode catalyst layer of the membrane-electrode assembly each independently comprises a catalyst selected from the group consisting of platinum, ruthenium, osmium, platinum-ruthenium alloys, platinum-osmium alloys, platinum-palladium alloys, platinum-cobalt alloys, platinum-nickel alloys, and combinations thereof.

15. The fuel cell of claim 11, wherein the gas diffusion layers are formed of carbon paper or carbon cloth.

16. The fuel cell of claim 11, further comprising at least one microporous layer between one of the catalyst layers and the corresponding gas diffusion layer.

17. The fuel cell of claim 16, wherein the microporous layer comprises a material selected from the group consisting of graphite, carbon nanotubes (CNT), fullerene (C60), activated carbon, carbon nanohorns, and carbon black.

18. The fuel cell of claim 10, wherein the fuel cell is a self-humidifying fuel cell that does not require an additional humidifier.
